(19) United States
(12) Patent Application Publication
(10) Pub. No.: US 2023/0252534 A1
(43) Pub. Date: Aug. 10, 2023

(54) BLOCKCHAIN ENABLED NUTRITION STATION

(71) Applicant: VeriTX Corp., Buffalo, NY (US)

(72) Inventor: James Allen Regenor, East Aurora, NY (US)

(21) Appl. No.: 18/132,757

(22) Filed: Apr. 10, 2023

Related U.S. Application Data
(63) Continuation of application No. 17/349,613, filed on Jun. 16, 2021.
(60) Provisional application No. 63/039,700, filed on Jun. 16, 2020.

(51) Int. Cl. G06Q 30/02; G07F 9/00

(52) U.S. Cl. CPC G06Q 30/0281; G07F 9/006; G07F 9/001; G06Q 2220/00

(57) ABSTRACT

A blockchain traceable nutrition station, such as a vending machine is provided. All products sold within the nutrition station may be carbon neutral or use green energy during their production, processing and/or product manufacturing. All products are blockchain tracked and traced from their source to the nutrition station machine. Each product includes a unique identifier viewable on the nutrition station machine or through a mobile application viewable on a purchaser's smart device for displaying the product blockchain information.

### BACKGROUND OF THE INVENTION

The present invention broadly relates to the use of blockchain for tracing purposes and more particularly relates to a blockchain for agriculture and still more particularly to a blockchain traceable nutrition station.

### SUMMARY OF THE INVENTION

The present invention provides in a first aspect a blockchain traceable nutrition station, such as but not limited to a vending machine. In a preferred embodiment all products sold within the nutrition station are carbon neutral or use green energy during their production, processing and/or product manufacturing. The product origin and characteristics such as organic non-GMO are recorded in the product provenance on the blockchain.

In an embodiment, all products are blockchain tracked and traced from their source to the nutrition station machine in which they are sold with a unique identifier viewable on the nutrition station machine or through a mobile application viewable on a purchaser's smart device.

In an embodiment, the nutrition station machine may use stable coin direct from a digital wallet to complete the food purchase transaction.

In an embodiment the machine may be operable to create aggregate data sets.

The consumables which are stocked in the nutrition station machine may be offered in any desired food type category, such as gluten free, dairy free and/or nut free, non-GMO, and organic for example.

Additional objects, advantages and novel aspects of the present invention will be set forth in part in the description which follows, and will in part become apparent to those in the practice of the invention, when considered with the attached figure.

### DESCRIPTION OF THE DRAWING FIGURES

The above-mentioned and other features and advantages of this invention, and the manner of attaining them, will become apparent and be better understood by reference to the following description of the invention in conjunction with the accompanying drawing, wherein:

FIG. 1 is a simplified diagrammatic view of a blockchain traceable nutrition station in accordance with an embodiment of the invention.

FIG. 2 is an exemplary schematic of blockchain tracing of product data from source to nutrition station for presentation to purchaser.

### DETAILED DESCRIPTION OF A PREFERRED EMBODIMENT

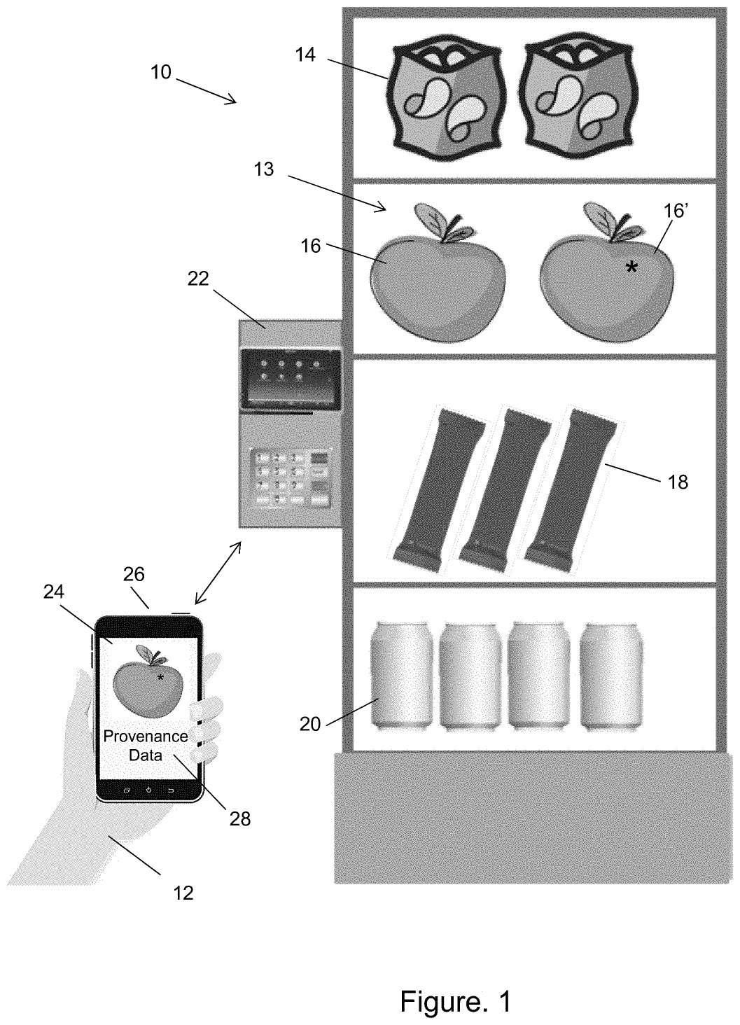

FIG. 1 illustrates an embodiment of the invention comprising a nutrition station 10 which may be in the form of a food vending machine. Nutrition station 10 may be stocked with a variety of different foods available for selection and purchase by a consumer 12. In an embodiment, the machine 10 includes consumables 13, such as, for example and without limitation thereto, snack chips 14, apples 16, nutrition bars 18 and beverages 20, each of which is blockchain tracked and traced to its source with a unique identifier viewable on machine interface 22 or a mobile application 24 on a consumer's 12 smart device 26. In one non-limiting embodiment, machine 10 may use stable coin direct from a digital wallet to complete the food purchase transaction. Machine 10 may be further operable to create aggregate data sets.

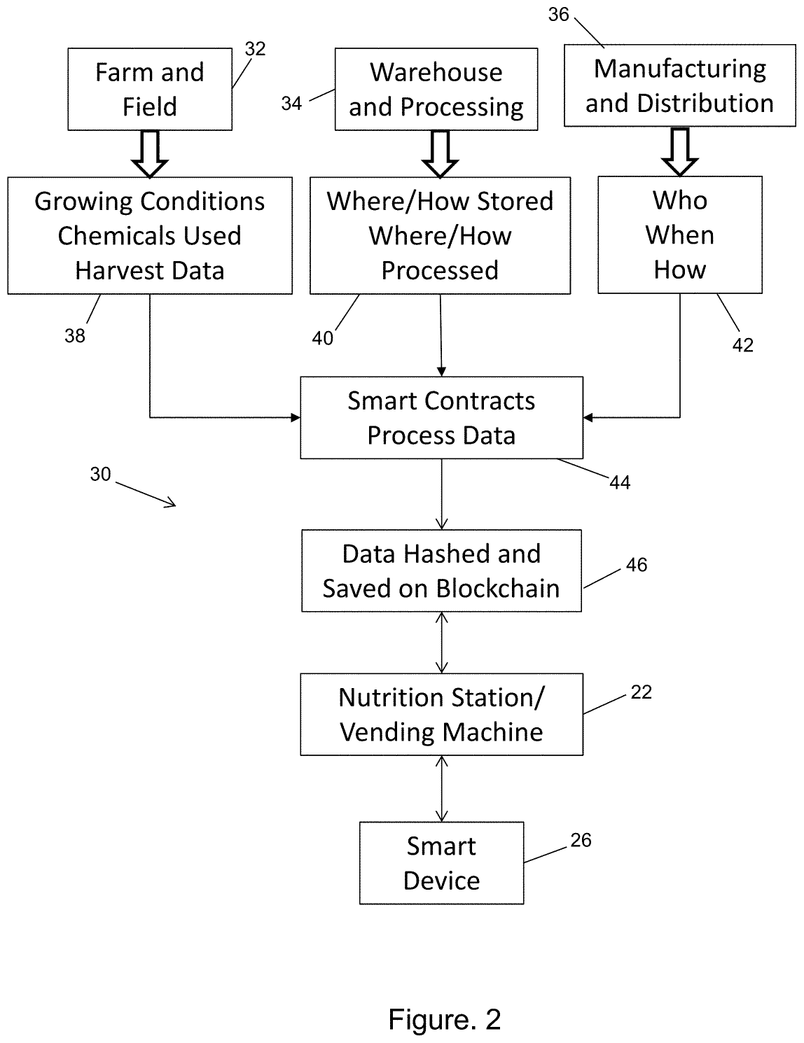

Consumables 13 stocked in machine 10 may be offered in any desired food type category, such as allergen free (e.g., gluten, dairy, peanut and/or tree nut), non-GMO (non-genetically modified) and/or chemical free (e.g., pesticides, hormones, etc.), for example. As will be described in greater detail below with regard to FIG. 2, consumer 12 may select a particular consumable, such as apple 16′ for potential purchase. Blockchain data, including apple 16′ provenance may be shown on machine interface 22 or may be encoded, such as through a QR code scannable by smart device 26, whereby apple 16′ provenance 28 is viewable on smart device 26. Consumer 12 may then review provenance 28 prior to purchase. By way of example, apple 16′ may have been grown at an orchard that used a particular pesticide on its apple trees. Consumer 12 may not wish to purchase such an apple grown with pesticides and elect to cancel the transaction prior to purchase.

Turning now to FIG. 2, an exemplary schematic of blockchain data tracing 30 is shown. For purposes of example and without limitation solely thereto, in one aspect of the present invention, consumable 13 data may be segregated into three generalized classes, for example, farm and field data 32, warehouse and processing data 34 and manufacturing and distribution data 36.

A non-exhaustive list 38 of farm and field data 32 may include relevant growing conditions of the consumable (e.g., average daily temperature, crop watering data, etc.), any chemicals used prior to and/or during the growing season and harvest data, such as date of harvest, method of harvest, laborers used during harvest, etc.

A non-exhaustive list 40 of warehouse and processing data 34 may include where, how long and what were the environmental storage conditions of the farm produce prior to processing (if any), as well as any processing of the farm produce, such as where and how the produce was processed and including exemplary information such as whether processing used shared equipment or shared space with common allergen contamination sources, such as gluten, peanuts and tree nuts.

A non-exhaustive list 42 of manufacturing and distribution data 36 may include manufacturer data, such as manufacturer identity, location, as well as a list of ingredients used in the final, manufactured consumable product. In accordance with an aspect of the present invention, each individual ingredient used in a final product will have its own blockchain data 32, 34, and 36. Further information may include distributor data, such as name, how the product was transported and when the product was distributed to the vendor.

As farm and field data 32, warehouse and processing data 34 and manufacturing and distribution data 36 are generated, smart contracts 44 are executed and the data is processed. The data is then hashed and saved to blockchain 46. Each consumable 13 may then be assigned a unique QR code which correlates to the blockchain. Consumable 13 and its QR code may then be loaded into machine 10 for vending. As discussed above, a potential consumer can scan the consumable 13 QR code which will then retrieve and display the blockchain data for that particular consumable 13, including farm and field data 32, warehouse and processing data 34 and manufacturing and distribution data 36 for each constituent within consumable 13. As a result, consumer 12 may make a fully informed decision regarding the purchase and consumption of any consumable 13.

While the apparatus, methods and systems have been shown and described with reference to certain preferred embodiments thereof, it will be understood by those skilled in the art that various changes in form and details may be made therein without departing from the spirit and scope of the invention as defined by the claims which follow.

1. (canceled)

2. A method for dispensing blockchain traceable consumables, the method comprising:
a) providing a blockchain enabled nutrition station comprising a vending machine and a user interface including a first processor, a first memory, a first display and a communication module;
b) stocking the vending machine with a plurality of consumables, wherein each consumable of said plurality of consumables is assigned a unique identifier and wherein blockchain provenance data has been assigned to said each consumable based upon said unique identifier, wherein said blockchain provenance data includes one or more of farm and field data, warehousing and processing data, and manufacturing and distribution data;
c) receiving a consumer input through the user interface designating a consumer-selected consumable from among the plurality of consumables;
d) retrieving blockchain provenance data from a distributed ledger for the consumer-selected consumable;
e) displaying on said first display the retrieved blockchain provenance data to the consumer; and
f) dispensing from the vending machine the consumer-selected consumable to the consumer following completion of an authorized transaction.

3. The method of claim 2 wherein the completion of the authorized transaction comprises:
a) acceptance of the retrieved blockchain provenance data and the consumer-selected consumable by the consumer; and
b) confirmation of payment via the user interface.

4. The method of claim 3 wherein payment is through a digital wallet used by the consumer.

5. The method of claim 2 wherein the farm and field data includes one or more of consumable growing conditions, chemicals used and harvest data; the warehousing and processing data includes one or more of environmental storage conditions prior to processing, processing data of the consumable including shared equipment and shared spaced data; and the manufacturing and distribution data includes one or more of manufacturer identity and location, ingredient list of the consumable, and the name and transportation data for each distributor.

6. The method of claim 2 wherein each unique identifier is assigned a unique QR code.
